(19) United States
(12) Patent Application Publication
(10) Pub. No.: US 2026/0197062 A1
(43) Pub. Date: Jul. 9, 2026

(54) METHODS FOR CHANNEL GENERATION AND CHANNEL PARAMETER ESTIMATION USING PHYSICS CONSTRAINED MACHINE LEARNING MODELS

(71) Applicant: InterDigital Patent Holdings, Inc., Wilmington, DE (US)

(72) Inventors: Akshay Malhotra, San Jose, CA (US); Shahab Hamidi-Rad, Sunnyvale, CA (US); Aditya Sant, Los Altos, CA (US); Satyavrat Wagle, West Lafayette, IN (US)

(73) Assignee: InterDigital Patent Holdings, Inc., Wilmington, DE (US)

(21) Appl. No.: 19/009,977

(22) Filed: Jan. 4, 2025

(51) Int. Cl. H04B 7/06; H04L 41/16

(52) U.S. Cl. CPC H04B 7/0634; H04B 7/0617; H04B 7/0663; H04L 41/16

(57) ABSTRACT

A wireless transmit/receive unit (WTRU) may sample a latent vector from a pre-defined channel distribution. The WTRU may input the latent vector to a trained generative artificial intelligence (AI)/machine learning (ML) model. The trained generative AI/ML model may be trained to output channel-related parameters associated with each path of a plurality of paths of an over-the-air (OTA) communication channel based on the latent vector. The WTRU may input the channel related parameters associated with each path of the plurality of paths of the OTA communication channel to a non-AI/ML model. The non-AI/ML model may be configured to produce a channel matrix. The WTRU may use the channel matrix to perform one or more of a channel state information (CSI) compression, CSI prediction, beamforming, positioning, and/or performance monitoring.

### BACKGROUND

An artificial intelligence (AI)/machine learning (ML) model may be trained for being implemented in various environments. For example, an AI/ML model may be trained using a loss function for being implemented in a wireless communication environment. However, the structure of the AI/ML model may prevent generation of actual or appropriate channel characteristics during implementation or inference.

### SUMMARY

Embodiments described herein include methods for generating wireless channel data using physics constrained generative machine learning models, which may include specific properties and/or structure in the generated channel. Embodiments described herein include methods for training physics constrained generative models under high degree of non-convexity. Embodiments described herein include methods for channel parameter estimation using unsupervised autoencoders.

A wireless transmit/receive unit (WTRU) may sample a latent vector from a pre-defined channel distribution. The WTRU may input the latent vector to a trained generative artificial intelligence (AI)/machine learning (ML) model. The trained generative AI/ML model may be trained to output channel-related parameters associated with each path of a plurality of paths of an over-the-air (OTA) communication channel based on the latent vector. The WTRU may input the channel related parameters associated with each path of the plurality of paths of the OTA communication channel to a non-AI/ML model. The non-AI/ML model may be configured to produce a channel matrix. The WTRU may use the channel matrix to perform one or more of a channel state information (CSI) compression, CSI prediction, beamforming, positioning, and/or performance monitoring.

The trained generative AI/ML model may include a generative adversarial network (GAN) generator model and/or a trained decoder of an autoencoder.

The non-AI/ML model may include a physics-based model. The trained generative AI/ML model and/or the physics-based model may be portions of a hybrid model configured to operate on the WTRU.

The physics-based model may include a predefined channel parameter dictionary. The channel-related parameters may be configured to operate as weights for the predefined channel parameter dictionary of the physics-based model.

The WTRU may use a factorized gain tensor algorithm associated with the channel parameter dictionary to determine the channel matrix.

The WTRU may receive configuration information including at least one model type associated with the generative AI/ML model and/or at least one model type associated with the physics-based model. The WTRU may receive configuration information including one or more AI/ML parameters associated with the generative AI/ML model. The WTRU may train the generative AI/ML model based on the one or more AI/ML parameters. The one or more AI/ML parameters may include one or more of a generative model training strategy, a model architecture, parameters, hyperparameters, and/or criteria to stop the training of the generative AI/ML model.

The configuration information may include a loss function. The WTRU may train the generative AI/ML model based on the loss function and/or training data.

The generative AI/ML model may include an autoencoder. The WTRU may input wireless channel matrices as training data into an encoder of the autoencoder. The encoder may be configured to output parameters relating to the latent vector for training the decoder of the autoencoder.

The configuration information may include channel-related parameters associated with the physics-based model. The channel-related parameters associated with the physics-based model may include one or more of a number of paths associated with the plurality of paths, an angle of arrival associated with each path of the plurality of paths, a path loss coefficient associated with each path of the plurality of paths, a delay spread associated with each path of the plurality of paths, a doppler value associated with each path of the plurality of paths, and/or a delay spread associated with each path of the plurality of paths.

The WTRU may send a report to a network entity. The report may include an indication of the channel matrix.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 depicts an example (e.g., overall) block diagram for the channel construction.

FIG. 3 depicts an example of training a variational auto-encoder.

FIG. 4 depicts an example diagram illustrating inference with a variational auto-encoder.

FIG. 5 depicts an example of training and/or inference using a generative adversarial network (GAN).

FIG. 6 depicts an example diagram of inference with a GAN.

FIG. 7 depicts an example approach for channel construction using the gain tensor and/or parameter dictionary.

FIG. 8 depicts an example of Canonical Polyadic Decomposition (CANDECOMP) for a 3-dimensional rank-R tensor.

FIG. 9 depicts an example approach for channel construction using the factorized gain tensor.

FIG. 10 depicts an example architecture of the variational auto-encoder (VAE) based generative model used for training.

### DETAILED DESCRIPTION

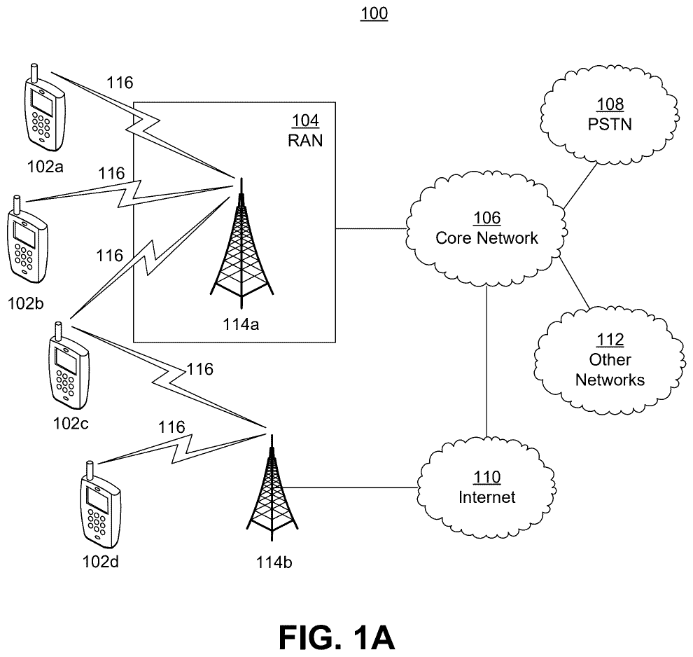

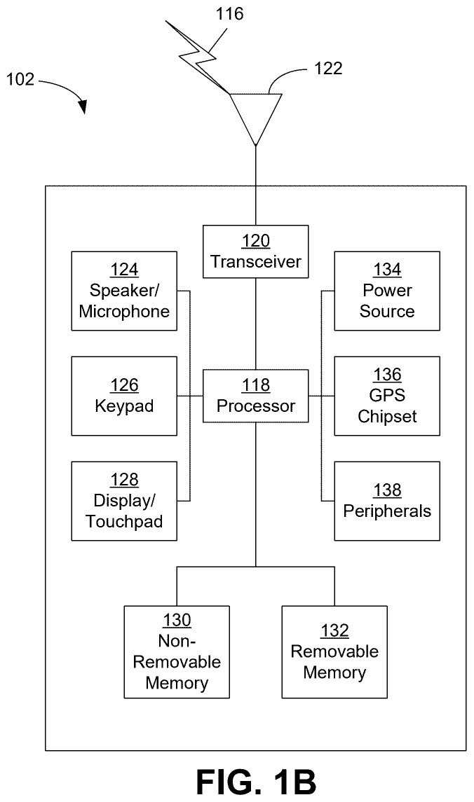

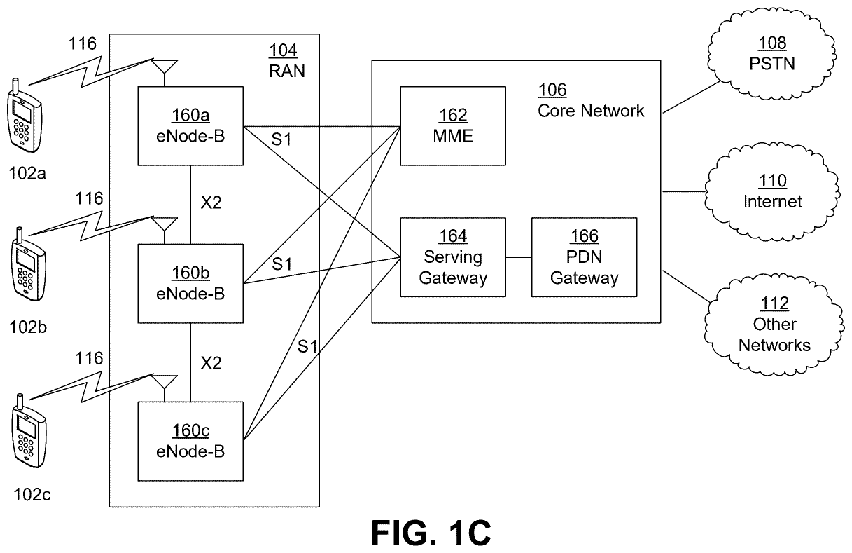

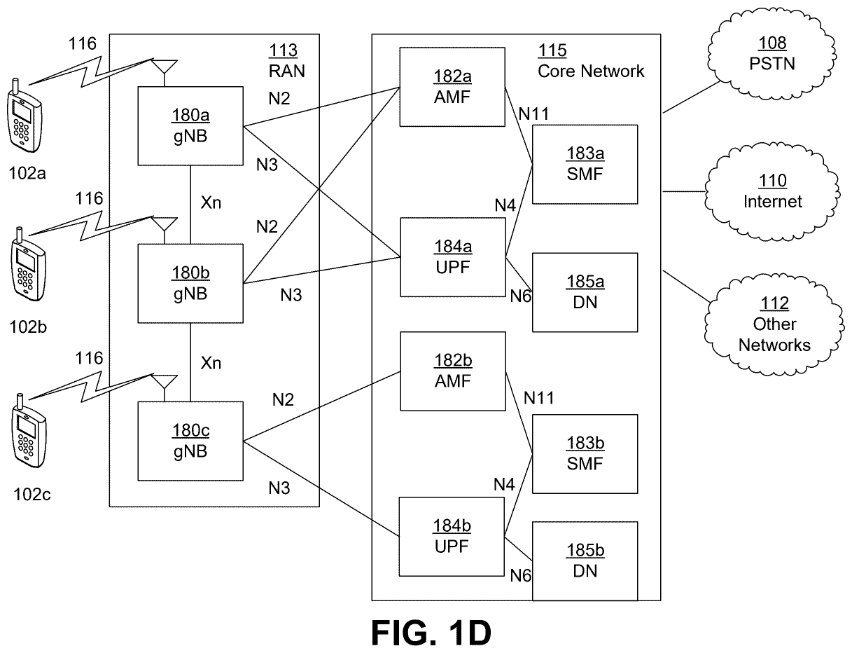

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11(i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

With the use of AI/ML becoming more and more popular in wireless communication, these methods may start getting deployed in communication systems. To achieve the improved performance with ML methods, model training pipelines require the availability of a large amount of data. However, the process of manually collecting, cleaning and labelling wireless data from the real world is often complex and expensive both in terms of resources and time. To that end, generative models have been proposed to mitigate this problem by artificially synthesizing wireless data, significantly reducing the effort required to create wireless datasets for the aforementioned applications.

Additionally, to incorporate capabilities around online training and fine tuning of ML models in wireless, it's important to be able to efficiently share and exchange the datasets between UEs and base stations (BS), however sharing the entire dataset having tens of thousands of data points or even millions of data points between UE/BS entities is not always practically feasible. Generative model can potentially alleviate some of these problems by allowing the exchange of generative models (instead of the data itself), which can be sampled to produce the data.

The process of manually collecting, cleaning, and/or labeling wireless data from the real world may (e.g., often) be complex and/or expensive in terms of resources and/or time. Generative models may be proposed to mitigate this problem by, for example, artificially synthesizing wireless data, which may (e.g., significantly) reduce the effort required to create wireless datasets for one or more applications (e.g., as described herein).

Additionally or alternatively, to incorporate capabilities around online training and/or fine tuning of ML models in wireless, efficiently sharing and/or exchanging the dataset(s) between WTRUs and base stations (BSs) may be included. Sharing the entire dataset having tens of thousands of data points (e.g., millions of data points) between WTRUs and BSs may not (e.g., always) be practically feasible. Generative model(s) can alleviate one or more (e.g., some) of these problems by, for example, allowing the exchange of generative models (instead of the data itself), which can be sampled to produce the data.

Collecting high quality over-the-air (OTA) wireless channel data at scale may have been a hard problem to solve, as collecting a large amount of such data may be burdened by high resource cost and/or large time complexity. In the absence of large OTA datasets, ML applications in the wireless domain may have been based on synthetic datasets to develop, test, and/or standardize ML models. Studying and/or deploying ML models trained and/or examined in (e.g., purely) synthetic scenarios can be (e.g., extremely) dangerous as their performance may not generalize to real world settings.

To address this and/or similar problem(s), the use of generative models have been explored (e.g., in recent years) to synthesize realistic wireless channel data. These approaches may synthesize outputs, which may not correspond to valid channels and/or may not provide (e.g., any) insight into the scenario(s) of interest. To address these issues, embodiments described herein may include a generative model that leverages (e.g., proven) parametric channel modelling framework(s) to produce channel matrices and/or their associated parameters, which may ensure their validity. Additionally or alternatively, the generated parameters may provide information about the scenario, which may allow deeper insights into the associated environment. Non-convex nature of parametric channel models may be mitigated by performing a linear relaxation, which may allow a consistent gradient flow through the generative model.

Embodiments described herein include physics constrained generative channel model(s) for generating multiple input multiple output (MIMO) data. Methods for generating wireless channel data using ML are described herein. A physics-based constraint in the generative process may ensure that the channels being generated by the ML model are (e.g., all) viable from a physics perspective and/or obey a pre-specified channel model.

A WTRU may receive configuration information associated with one or more of the following. The WTRU may receive configuration information associated with generative model training strategy (e.g., generative adversarial network (GAN), variational auto-encoder (VAE), Diffusion, etc.). The configuration information may include a loss function. The WTRU may receive configuration information associated with the model architecture to use for training. The model architecture to use for training may include one or more of a backbone (e.g., fully connected, Resnet, transformer, etc.), a number of layers, architecture, activation(s), VAE bottle neck, latent space distribution, one or more training parameters, one or more training hyperparameters, and/or a stopping criterion. For example, the WTRU may receive configuration information including one or more AI/ML parameters associated with the generative AI/ML model. The WTRU may receive configuration information associated with parameter(s) associated with the physics-based model. The parameters may include a model type (e.g., cluster-delay line model (CDL), time delay line model (TDL), Nearfield/farfield, etc.). The WTRU may receive configuration information including at least one model type associated with the generative AI/ML model and/or at least one model type associated with the non-AI/ML (e.g., physics-based) model. For example, the model may include

$${\sum }_{k = 1}^{{N}_{p}} {b}_{k} {a}_{R} ( {θ}_{k} ) {a}_{T}^{H} ( {ϕ}_{k} ) \vert ,$$

where θ_k may represent the azimuth angle of arrival (AoA), and/or φ_k may represent the azimuth angle of departure (AoD), and/or b_k may represent gain. The WTRU may receive configuration information associated with model parameters (e.g., number of paths, angle of arrival (AoA), zenith AoA (ZoA), angle of departure (AoD), zenith AoD (ZoD), gain/path loss, phase, doppler, path delay, delay spread, etc.). The WTRU may receive configuration information associated with the optimization reformulation and/or relaxation parameters (e.g., parameter quantization level(s) for each parameter). For example, the WTRU may receive configuration information associated with a range of AoA, a range associated with AoD, a number of discrete AoA angles, a number of discrete AoD angles, and/or a number of discrete phase angles. The WTRU may utilize information about available computational capabilities and/or memory to select one or more (e.g., some) of the parameters (e.g., as described herein).

A WTRU may perform training of the generative model. The WTRU may train the generative AI/ML model based one or more AI/ML parameters. The one or more AI/ML parameters may include one or more of: a generative model training strategy, a model architecture, parameters, hyperparameters, and/or criteria to stop the training of the generative AI/ML model. The WTRU may train the generative AI/ML model based on the loss function and/or training data. The WTRU generative model may introduce physics-based constrained into the (e.g., overall) generative model architecture and/or training (e.g., channel model). The generative model may include an (e.g., overall) combined architecture. The WTRU may apply a grid-based simplification for the azimuth (e.g., only) setup. For example, the grid-based simplification may include a non-trainability and/or non-convexity of the original problem. For example, the grid-based simplification may include relaxing and/or simplifying the (e.g., overall) problem. The grid-based simplification may include one or more details regarding successful training. Successful training may indicate the model has converged and/or the model has met the required performance criterion (e.g., the loss has reached below a certain threshold). The WTRU may apply a tensor-based simplification for the multi-dimensional multi parameter setup. For example, after simplification is applied, the training of the generative model can be performed. The generative model (e.g., decoder) may predict the tensor component(s) and/or factor(s) (e.g., instead of the complete tensor). The generative AI/ML model may include an autoencoder. The WTRU may be configured to input wireless channel matrices as training data into an encoder of the autoencoder. The encoder may be configured to output parameters relating to the latent vector for training the decoder of the autoencoder.

A WTRU may utilize the trained model for data generation and/or task specific model training. For example, the WTRU may sample a latent vector from a pre-defined distribution. The WTRU may input the latent vector to a trained generative AI/ML model. The trained generative AI/ML model may include a generative adversarial network (GAN) generator model and/or a trained decoder of a variational autoencoder and/or a different generative model. The trained generative AI/ML model may be trained to output channel-related parameters associated with each path of a plurality of paths of an over-the-air (OTA) communication channel based on, for example, the latent vector. The WTRU may input the channel-related parameters associated with each path of the plurality of paths of the OTA communication channel to a non-AI/ML (e.g., physics-based) model. The non-AI/ML model may be configured to produce a channel matrix. The non-AI/ML model may include a physics-based model (e.g., as described herein). The trained generative AI/ML model and/or the physics-based model may be portions of a hybrid model configured to operate on the WTRU. The WTRU may run the model in inference mode for data generation. The WTRU may train task specific model(s) (e.g., channel state information (CSI) compression, CSI prediction), beamforming, etc.) on the generated datasets. For example, the WTRU may use the channel matrix to train models for one or more different applications like, CSI compression, CSI prediction, beamforming, positioning, and/or performance monitoring.

A WTRU may transmit the trained generative model or model parameters/hyperparameters to the base station (BS) for data generation. For example, the WTRU may send a report to a network entity. The report may include an indication of the channel matrix.

Embodiments described herein may include an auto-encoder based unsupervised channel parameter estimation. A method for unsupervised training and/or decomposition of wireless channel tensors into path wise components associated with the multipath channel may be described herein.

A WTRU may receive configuration associated with parameters to be estimated. The WTRU may receive one or more of the following. The WTRU may receive a maximum number of paths that can be estimated and/or an energy threshold associated with the number of paths to be considered. The WTRU may receive angle(s) to be estimated and/or their range. For example, the WTRU may receive azimuth (e.g., only) (e.g., AoA, AoD), elevation (e.g., only) and/or azimuth and elevation. For example, the WTRU may receive a range of each angle AoA, ZoA, AoD, and/or ZoD range. The WTRU may receive a path loss/gain value(s) and/or the associated range. The path loss may be complex and/or real path loss. The WTRU may receive a phase associated with the pathloss/gain and/or associated range. The WTRU may receive a doppler parameter and/or an associated speed and/or phase range. The WTRU may receive a delay spread parameter and/or an associated range. For example, the configuration information may include the channel-related parameters associated with the non-AI/ML (e.g., physics-based) model. The channel-related parameters associated with non-AI/ML (e.g., physics-based) model may include one or more of a number of paths associated with the plurality of paths, an angle of arrival associated with each path of the plurality of paths, an angle of departure associated with each path of the plurality of paths, a path loss coefficient associated with each path of the plurality of paths, a delay spread associated with each path of the plurality of paths, a doppler value associated with each path of the plurality of paths, and/or a delay spread associated with each path of the plurality of paths.

The WTRU may receive configuration about the channel model to be considered (e.g., CDL, TDL, Nearfield, etc.).

The WTRU may receive configuration about the parameter estimation to be used (e.g., autoencoder based unsupervised estimation, optimization based unsupervised estimation, supervised deep learning based estimation).

The WTRU may receive reference symbol(s) and/or pilot(s) and/or may perform channel estimation, and/or may determine the channel parameters including one or more of the following. The WTRU may determine an actual number of paths in the channel Actual number of paths in the channel N_p. The WTRU may determine one or more parameters associated with each of the N_p paths (e.g., angle of arrival (AoA) θ_k, angle of departure (AoD) φ_k, Path loss/gain b_k, f_k doppler, δ_k delay, etc.).

The WTRU may utilize the estimated parameters for one or more (e.g., downstream) tasks. For example, the WTRU may utilize the estimated parameters for CSI compression (e.g., reporting the dominant paths and/or associated parameters), CSI prediction (e.g., tracking the dominant paths), beamforming indicating and/or leveraging AoA and/or AoD associated with the dominant paths, positioning (e.g., using the multipath information for positioning), and/or performance monitoring.

In examples, a WTRU may be configured to train, utilize, and/or transmit a generative model for the purpose(s) of data generation. The WTRU may be configured to generate multiple input multiple output (MIMO) channel data sample(s). For the purposes of MIMO channel data generation, for example, the WTRU may receive a set of configuration parameters from the network associated with the configuration of the ML and/or deep learning (DL) model(s) and/or the physics based model to be integrated with the ML/DL model.

In examples, the WTRU may receive configuration associated with the general class and/or type of generative model to be used. For example, the generative model to be used could be a generative adversarial network (GAN), and/or may be a variational auto-encoder (VAE) based model and/or a diffusion-based generative model, etc.

In examples, the WTRU may be configured with the details associated with the generative model architecture. In relation to the architecture details, the WTRU may be configured with the backbone architecture of the model, for example, a fully convolutional architecture backbone including convolutional neural network layers, and/or a residual network (resnet) model, and/or a transformer model with the self attention layers, and/or a fully connected model, and/or a recurrent neural network, etc. The WTRU may (e.g., also) be configured with the number and/or type of layers in the model and/or their arrangement, the number of weights and/or parameters associated with each layer, the activation associated with the output of each layer (for e.g., Relu, leaky-Relu, sigmoid, etc.), etc.

In examples, the WTRU may be (e.g., also) configured with the architecture details associated with a specific type of model. For example, in the case of VAE based generative model, the WTRU may be configured with the bottleneck layer of VAE (e.g., the dimensionality of the mean, variance vectors). The WTRU may (e.g., also) be configured with the desired distribution of the latent space (e.g., gaussian, gaussian mixture model, Laplacian, uniform, etc.).

In examples, the WTRU may be configured with the training parameters and/or hyperparameters for designing and/or training the model. The training parameters and/or hyperparameters may include, for example, one or more of: a batch size, a number of training steps and/or batch size, a learning rate, an optimizer to be used (e.g., Adam, stochastic gradient descent (SGD), etc.), stopping criterion, and/or the like. For example, the WTRU may receive configuration information including one or more AI/ML parameters associated with the generative AI/ML model.

In examples, the WTRU may be configured with the type of physics-based model related to channel generation. For example, the physics-based model may be CDL, TDL, Saleh-Valenzuela model, and/or other geometric and/or stochastic model(s) and/or nearfield and/or far field model(s).

In examples, the WTRU may receive parameters associated with the physics-based model to be considered. For example, the WTRU may be configured with the maximum number of paths to be considered for the physics-based model, and/or the number of multipath clusters associated with the model and/or the number of paths per cluster, etc. The WTRU may (e.g., further) receive an energy threshold governing the total energy of the channel up to which the most dominant path(s) may be considered.

In examples, the WTRU may receive the set of other parameter(s) that may be considered for the physics-based model. For example, the WTRU may receive the AoA and/or AoD for each path and/or path cluster (e.g., the angles may be evaluated across the azimuth only, and/or elevation only, and/or both azimuth and elevation). The WTRU may receive, for each path and/or path cluster AoA-azimuth angle of arrival, ZoA-elevation angle of arrival, AoD-azimuth angle of departure, ZoD-elevation angle of departure. The WTRU may (e.g., also) be configured to utilize the path loss/gain associated with each path and/or path cluster and/or the phase associated with each path loss/gain.

In examples, the physics-based model may be parametrized to consider the doppler associated with (e.g., either) the overall channel, the cluster of paths and/or each path. The physics model may (e.g., also) be parametrized to consider path delays, the overall delay spreads, etc.

The WTRU side model may be configured to jointly utilize the ML/DL model in conjunction with the physics-based model to generate the channel data.

In examples, to simplify the computation associated with the complex physics-based model, the WTRU may be configured to utilize a specific kind of reformulation/relaxation/simplification. The WTRU may be configured with the reformulation-related configuration, which may include the type of reformulation (e.g., the joint tensor grid based reformulation, where a quantized version of some and/or all of the parameters may be utilized to consider a weighted combination of all possible parameter combinations across the quantized set of parameters). In examples, instead of estimating and/or generating the entire tensor (e.g., directly), a decomposed re-formulation may be considered, where the quantized levels associated with each parameter may be considered and/or learnt/trained independently and/or (e.g., then) combined to form the joint tensor. The WTRU may be configured with the range and/or resolution to be utilized for quantizing each of the parameter(s). For example, the angular range associated with azimuth angle of arrival (AoA), azimuth angle of departure (AoD), elevation angle of arrival (ZoA), and/or elevation angle of departure (ZoD) may be defined and/or the resolution of quantization and/or the number of steps/bins/levels for the quantization may be defined. The phase may be quantized and/or the angular range and/or resolution may be configured.

The WTRU may signal the computational capabilities and/or memory available for the generative channel modeling to the network, and/or the network may leverage this information for configuring the WTRU.

In examples, the WTRU may receive configuration associated with the parameters to be estimates. In one or more settings, the WTRU may be configured to estimate the maximum number of paths that can be and/or should be estimated. The WTRU may be configured with a threshold on the (e.g., overall) energy and/or the percentage of energy up to which the number of paths may be estimated and/or considered.

In examples, the WTRU may be configured with the angles to be estimated. For example, the WTRU may be configured to (e.g., just) estimate angle(s) of arrivals; in examples, the WTRU may be configured to estimate (e.g., only) the angle(s) of departure. In examples, the estimation may happen (e.g., only) along the azimuth plane and/or (e.g., only) along the elevation plane, and/or along (e.g., both) the planes. The WTRU may be configured with different range of angles to be considered for the angles of arrivals, departures, and/or along the azimuth and/or elevation plane(s).

In examples, the WTRU may be configured to estimate the path loss and/or gain value(s) associated with each path being estimated. The path loss/gain value(s) may be real and/or complex. In case of the real values, for example, the gain may represent (e.g., only) the magnitude associated with the path loss/gain; in the case of complex value(s), for example, the complex value(s) may represent (e.g., both) the magnitude and/or the associated phase.

In examples, the path loss and/or gain value may be considered to be a real value and/or the phase component may be (e.g., explicitly) estimated. Additionally or alternatively, the WTRU may be configured with a range of (e.g., potential) phase values to consider.

In examples, the WTRU may be configured to estimate the doppler parameter and/or doppler phase associated with each of the multipath components and/or may be configured to estimate the associated WTRU speed. The WTRU may be configured with the range of the phase to be considered and/or the range of the WTRU speed to be considered for the estimation.

In examples, the WTRU may be configured to estimate the path-wise delay(s) associated with one or more (e.g., some, all) of the multipaths. In examples, the WTRU may be configured to estimate the delay spread. The WTRU may (e.g., also) be configured with the (e.g., potential) range for the path-wise delay(s) and/or the delay spread.

Along with the range with each of the parameter(s) being measured (e.g., AoA, AoD, delay, doppler, etc.), for example, the WTRU may (e.g., also) be configured with the quantization parameters and/or the bin size and/or the required resolution associated with the estimation of each of the parameter(s). For a specific parameter, the (e.g., potential) range of values the WTRU can take may be divided into one or more (e.g., multiple) bins based on the specific parameter; the achieved performance and/or parameter estimation accuracy may be a function of this quantization parameter/bin size/resolution.

In examples, the WTRU may be configured to receive the type of channel model to be utilized for the parameter estimation process. For example, the WTRU may be configured with the CDL model, and/or the TDL model, and/or the nearfield model, and/or a different geometric model, etc.

The WTRU may (e.g., also) be configured with a specific type of parameter estimation method. In examples, the WTRU may be configured to utilize a supervised deep-learning model for the parameter estimation. In this setup, the deep learning model may be fed the channel matrix and/or a derived/processed version of the channel matrix, and/or one or more (e.g., some) features derived from the channel matrix; the model may (e.g., then) output the required channel-related parameters. In examples, an optimization-based unsupervised estimation may be utilized; a channel-related optimization may be used to estimate channel parameters. In examples, an autoencoder-based unsupervised estimation method may be utilized; a channel matrix and/or a processed version of the channel matrix may be utilized to estimate the channel parameter(s).

Embodiments described herein may include WTRU and/or network side model training. Embodiments described herein may include a forward model (e.g., an algorithm for channel construction from parameters). The (e.g., overall) strategy for the channel construction (e.g., for subsequent embodiments, the generative channel model, the parameter estimation model) from generated parameters

In examples, the channel construction may proceed through a set of explainable channel parameters that represent the different physical propagation and/or attenuation parameters of the channel. These may include the direction of arrival in the elevation plane, the direction of arrival in the azimuth plane, the direction of departure in the elevation plane, the direction of departure in the azimuth plane, the path loss coefficient, and/or a doppler shift. The channel parameters may be combined using a given physics-based model to create the output channel.

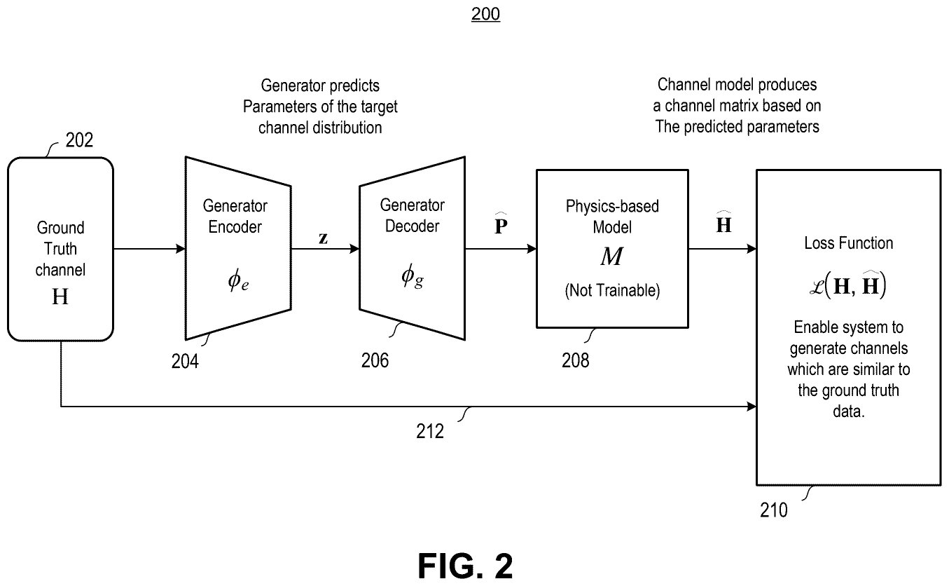

FIG. 2 depicts an example layout of the channel construction from a set of channel parameters. FIG. 2 depicts an example of an overall block diagram for the channel construction. The input channel may be used to extract the channel parameter(s), which may be used via the physics-based model to reconstruct the original channel matrix. For example, ground truth channel H 202 may be fed into a generator encoder 204. The generator encoder 204 may output a vector z. Vector z may be fed into generator decoder 206. The generator (e.g., 204, 206) may predict parameters of the target channel distribution. The generator decoder 206 may output channel parameters (e.g., p). The channel parameters may be fed into a non-AI/ML model (e.g., physics-based model) 208. The non-AI/ML model (e.g., physics-based model 208) may output a channel matrix/tensor A based on, for example, the predicted parameter(s). The channel matrix A may be fed into a loss function 210. At 212, the ground truth channel H 202 may be fed into a loss function 210.

Based on the type of physics-based model used, as shown in FIG. 2, the channel construction can be performed in different ways. In examples, the channel construction from the model parameters can be performed using two distinct approaches—the grid-less channel construction using the channel parameters, and/or the grid-based channel construction using the channel parameters.

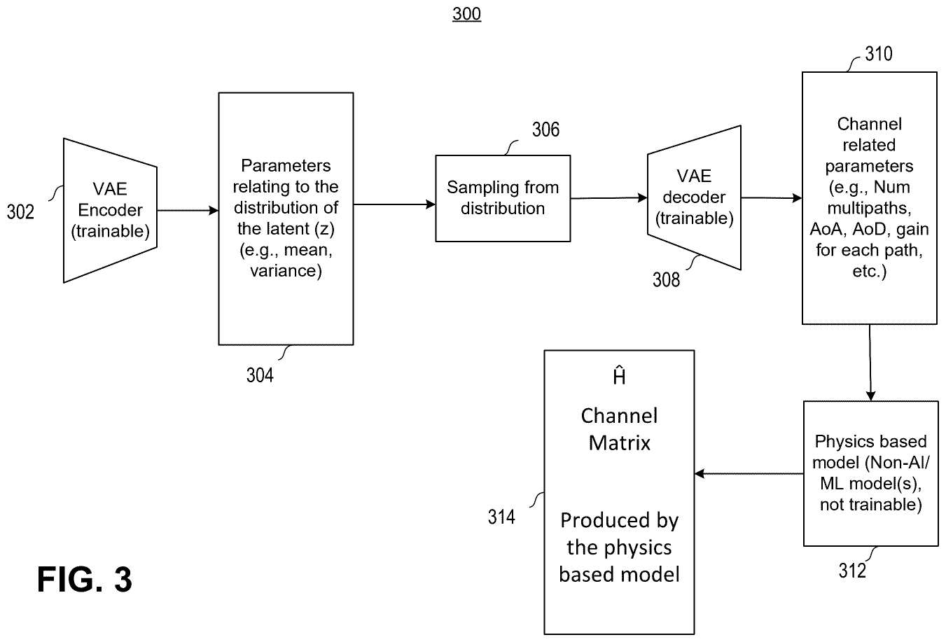

FIG. 3 depicts an example of training a variational auto-encoder 300. The training setup for the VAE model can be inferred from FIG. 3. A training dataset may include the wireless channel matrices/tensors used for training the model. The channel matrix/tensor may be fed to the encoder part of the VAE 302, which may output parameter(s) relating to the latent of the latent, z. Considering a latent vector z, of 10 dimensions and/or assuming learning a latent such that the latent is gaussian distributed, the VAE encoder model 302 may output two different 10 dimension AI vectors (e.g., one AI vector that corresponds to the mean of the latent distribution, one AI vector that corresponds to the variance of the latent distribution). For example, the VAE encoder 302 may output (e.g., at 304) one or more parameters relating to the distribution of latent (z) (e.g., mean, variance). Given the distribution related parameters that define the distribution, the distribution may be sampled (e.g., at 306). This 10 dimensional, sampled vector, may be fed to the VAE decoder 308. At 310, the VAE decoder 308 may output the channel related parameter(s) (e.g., the number of multipaths in a channel, AoA, AoD, gain, etc.) associated with each path, etc. These channel related parameters may be fed to the non-AI/ML physics-based model 312. At 314, for example, this model may produce a channel matrix H. During training, a loss function may be used for training the trainable component(s) of the VAE model. In FIG. 3, the trainable components may the VAE-encoder 302 and/or the VAE-decoder 308. The loss function of the VAE styled generative model may have at least two loss components. A first loss component may include an aim to minimize the loss between the actual channel (input) H and the final output channel matrix (estimated channel) H. A second loss component may regularize and/or enforce one or more (e.g., some) pre-defined structure(s) on the distribution of the latent vector z. An aim of the loss function may include the latent distribution to resemble a pre-defined distribution. Once the model has finished training, for example, the trained model can be utilized in inference mode operation to produce and/or generate channel matrices/tensors.

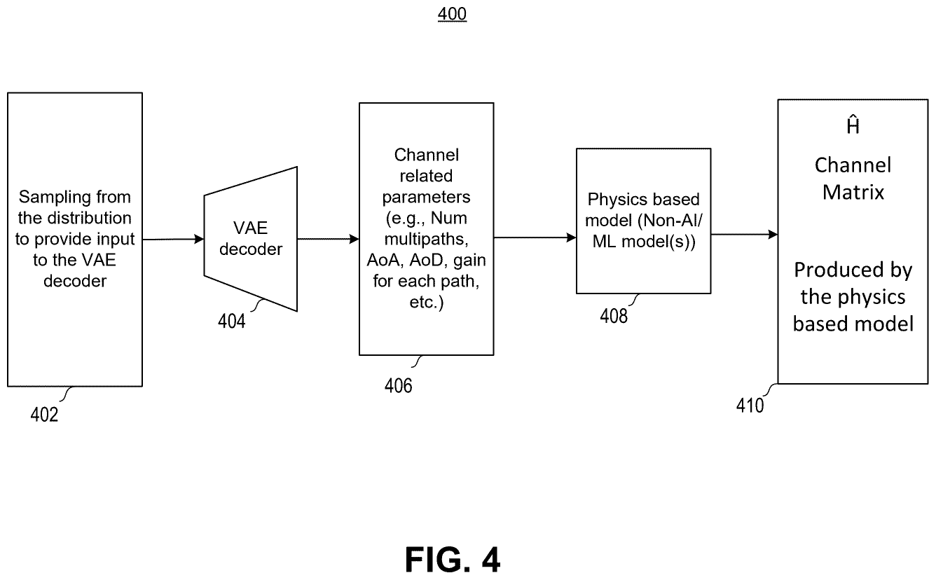

FIG. 4 depicts an example diagram illustrating inference with a variational auto-encoder 400. At 402, sample vector z from the pre-defined distribution may be fed to the (e.g., already trained) VAE decoder 404. At 406, the VAE decoder 404 may output the channel related parameters (e.g., the number of multipaths in a channel, AoA, AoD, gain, etc.) associated with each path, etc. These channel parameters may be fed to the non-AI/ML (e.g., physics-based) model 408. At 410, this model may produce a channel matrix/tensor H. Latent z from the predefined distribution may be sampled one or more times to provide as input (e.g., as described herein); as output, one or more channel matrices/tensors H may be obtained.

In this framework, the generative model may (e.g., directly) predict the channel related parameter(s). The predicted parameter(s) and/or variable(s) may include a number of multipaths, ZOA-elevation angle of arrival, ZoD-elevation angle of departure, gain for each path, etc. The parameter(s) (e.g., number of multipaths) may be inherently discrete and/or can take (e.g., only) positive integer values. One or more (e.g., other) parameter(s) (e.g., ZoA, ZoD, gain) may be (e.g., all) continuous parameter(s). The gridless construction model may utilize an (e.g., exact) physics-based model (e.g., as described herein) such as:

$$H = {\sum }_{p = 1}^{P} {g}_{p} {a}_{t} ( {θ}_{d}^{p} ) {{a}_{r} ( {θ}_{a}^{p} )}^{T}$$

where

$${a}_{t} ( {θ}_{d}^{p} ) = \frac{1}{\sqrt{{N}_{t}}} [ 1 , {e}^{( juSin ( {θ}_{d}^{p} ) )} , {e}^{( j 2 uSin ( {θ}_{d}^{p} ) )} , … , {e}^{( ju ( {N}_{t} - 1 ) S i n ( {θ}_{d}^{p} ) )} ] \qquad Equation ( 1 )$$

$${a}_{r} ( {θ}_{a}^{P} ) = \frac{1}{\sqrt{{N}_{r}}} [ 1 , {e}^{j u S i n ( {θ}_{a}^{p} )} , {e}^{j 2 u S i n ( {θ}_{a}^{p} )} , … , {e}^{j u ( {N}_{r} - 1 ) S i n ( {θ}_{r}^{p} )} ] . \qquad Equation ( 2 )$$

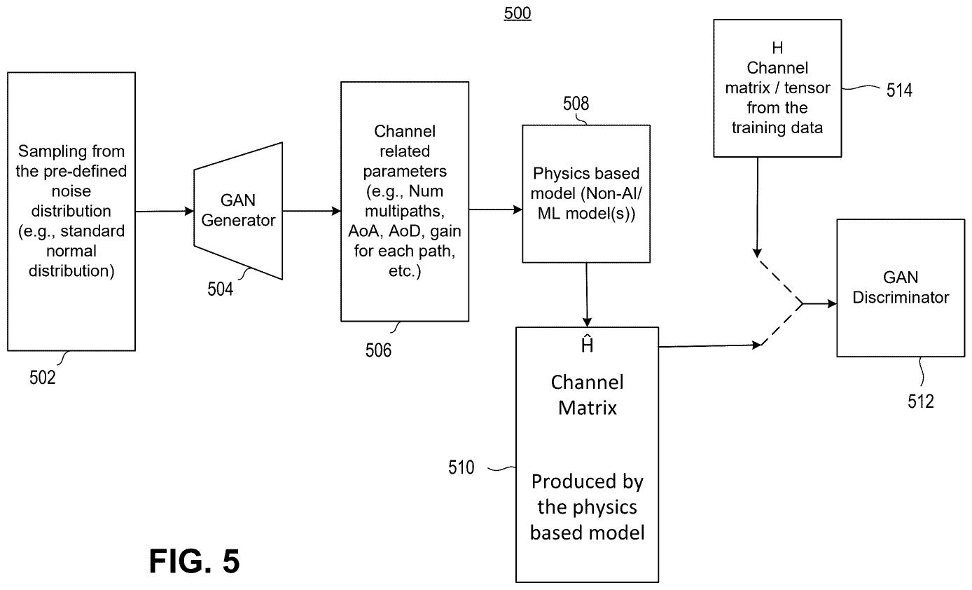

FIG. 5 depicts an example of training and/or inference using a generative adversarial network (GAN) 500. At 502, a noise vector z from the predefined distribution may be sampled and/or fed into the GAN generator model 504. The GAN generator model 504 may output (e.g., at 506), the channel related parameters (e.g., the number of multipaths in a channel, AoA, AoD, gain, etc.) associated with each path, etc. These channel related parameters may be fed to the non-AI/ML (e.g., physics-based) model 508. At 510, this model may produce a channel matrix/tensor H. The discriminator model (e.g., GAN discriminator 512) may learn to differentiate between the true channel samples coming from the training data H (e.g., at 514) and the generated channel matrices H (e.g., 510) created by the generator (GAN generator 504) (with the attached physics based model). The discriminator (e.g., GAN discriminator 512) may include a binary classifier, which may be given one channel input at a time; its objective may be to determine if the channel matrix is real channel coming (e.g., coming from the training dataset at 514) and/or if it is a generated/fake channel matrix (e.g., coming from the GAN generator 504 at 510). The training from the generator (e.g., GAN generator 504) and/or the GAN discriminator 512 may be carried out in an adversarial fashion. An objective of the GAN generator 504 may be to create channel samples that can fool the discriminator to think the generated channel is a real channel. The GAN discriminator 512 may be trained such that it can catch the generated channels and/or differentiate between real channels and generated channels. Post training, the inference can be carried out (e.g., only) using the generator model and/or by discarding the discriminator model.

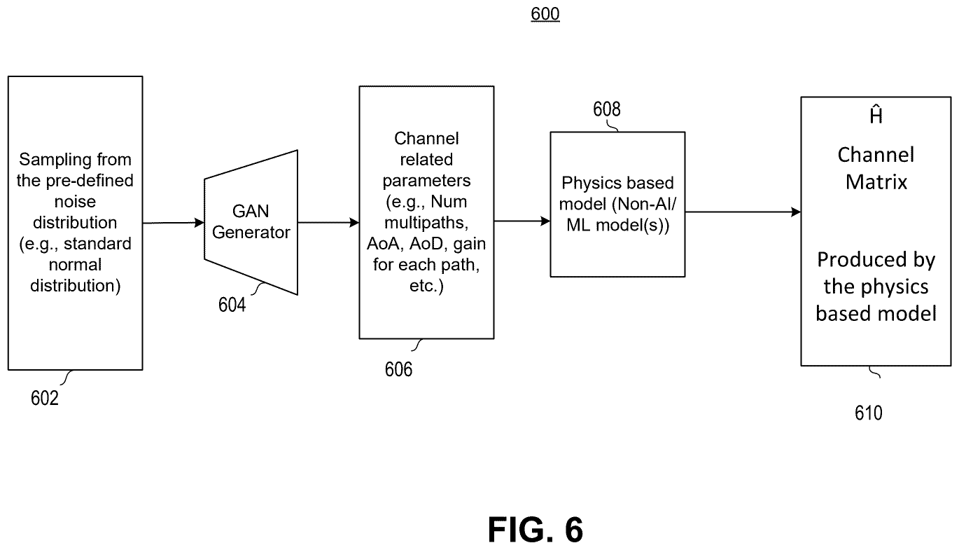

FIG. 6 depicts an example diagram of inference with a GAN 600. At 602, a noise vector z from the pre-defined distribution may be sampled and/or fed to the GAN generator model 604. The GAN generator model 604 may output (e.g., at 606), the channel related parameters (e.g., the number of multipaths in a channel, AoA, AoD, gain, etc.) associated with each path, etc. These channel related parameters may be fed to the non-AI/ML (e.g., physics-based) model 608. At 610, this model may produce a channel matrix/tensor H. Latent z from the predefined distribution may be sampled one or more times to provide as input (e.g., as described herein); as output, one or more channel matrices/tensors Ĥ may be obtained.

As described herein, for the inference stage in (e.g., both) the VAE and/or GAN frameworks may operate similarly. For example, a vector sampled from a pre-defined distribution may be fed into the generator block. This may output the channel related parameter(s). These parameter(s) may be fed into the non-AI/ML (e.g., physics-based) model to generate the channel matrix/tensor.

Embodiments may include a grid-less channel construction using the channel parameters. This framework may include the construction of the channel matrices using the array manifolds, computed using the channel parameters. As an example, consider that the set of channel parameters is given by

$$\hat{p} = [ {θ}_{a}^{1} , … {θ}_{a}^{P} , {θ}_{d}^{1} , … {θ}_{d}^{P} , {g}_{1} … {g}_{P} ] . {θ}_{d}^{p} , {θ}_{a}^{p} ,$$

and/or gₚ may be the angle of departure, angle of arrival and/or path gain for the p^{th} multipath component, respectively. The array manifolds are computed as follows.

$${a}_{t} ( {θ}_{d}^{p} ) = \frac{1}{\sqrt{{N}_{t}}} [ 1 , {e}^{( juSin ( {θ}_{d}^{p} ) )} , {e}^{( j 2 uSin ( {θ}_{d}^{p} ) )} , … , {e}^{( ju ( {N}_{t} - 1 ) S i n ( {θ}_{d}^{p} ) )} ] \qquad Equation ( 1 )$$

$${a}_{r} ( {θ}_{a}^{P} ) = \frac{1}{\sqrt{{N}_{r}}} [ 1 , {e}^{j u S i n ( {θ}_{a}^{p} )} , {e}^{j 2 uSi n ( {θ}_{a}^{p} )} , … , {e}^{j u ( {N}_{r} - 1 ) S i n ( {θ}_{r}^{p} )} ] . \qquad Equation ( 2 )$$

$${θ}_{d}^{p}$$

and/or

$${θ}_{a}^{p}$$

may be the angles of departure and arrival for the p^{th} multipath component, respectively. The scalars Nᵣ and/or Nₜ may be the number of receive and transmit antennas, respectively, and

$$u = \frac{2 π}{λ} d ,$$

with λ the wavelength of operation and d the inter-antenna element spacing. Based on these array manifolds, for example, the channel may be constructed as:

$$H = {\sum }_{p = 1}^{P} {g}_{p} {a}_{t} ( {θ}_{d}^{p} ) {{a}_{r} ( {θ}_{a}^{p} )}^{T} . \qquad Equation ( 3 )$$

gₚ may be the path gain for the p^{th} multipath component. Through this method, the channel may be constructed by measuring/estimating/generating the parameters (e.g., directly). There may be no assumptions on the channel parameters. The method may be harder to train, as the mean square error (MSE) loss landscape may be ill-conditioned. To avoid this limitation, a grid-based channel construction method may be utilized, as described herein.

Embodiments may include a grid-based channel construction using the channel parameters. To mitigate the problems caused by the ill-conditioned nature of the grid-less channel construction, for example, embodiments may include discretizing the parameter space using a predefined dictionary. Described herein is the design of the dictionary of the channel parameters, the channel construction by a weighted combination of the dictionary elements, and/or the channel construction using a factorized weight matrix weighted combination of dictionary elements. The WTRU may use a factorized gain tensor algorithm associated with the channel parameter dictionary to determine the channel matrix.

A channel parameter dictionary is described herein. The channel parameter dictionary may include discretizing over the space of one or more (e.g., all of the) parameters. The dictionary may be the result of the discretization process. For example, the angle of arrival and/or the angle of departure in the elevation plane may be discretized. In examples, the angle of arrival and/or the angle of departure along the azimuth and/or elevation may be discretized. Although the total number of channel parameters may be based on the number of multipath components in the channel, the dictionary size may (e.g., only) be based on the parameters per multipath and/or may be agnostic to the number of multipaths. The weight matrix (e.g., as described herein) may capture the number of multipaths and/or the (e.g., overall) effect of multipaths. The dictionary may (e.g., only) be defined for the angle of arrival and/or angle of departure in the elevation plane and/or not for each specific multipath; the channel parameter dictionary may be robust enough to accommodate (e.g., any number of) multipath components. For example, the non-AI/ML (e.g., physics-based) model may include a predefined channel parameter dictionary. The channel parameters may be configured to operate as weights for the predefined channel parameter dictionary (e.g., weights to be multiplied with the elements/entries of the channel parameter dictionary) of the non-AI/ML (e.g., physics-based) model.

A range of angles may (e.g., first) be referred to as [θₘᵢₙ, θₘₐₓ] and/or the resolution of discretization R, where R may represent the number of bins and/or levels in the discrete dictionary. The levels in the dictionary (and/or the bin sizes of the dictionary) may be spaced (e.g., equally spaced and/or unequally spaced).

For simplification, consider a set of 2 angles that may be estimated: elevation angle of arrival and elevation angle of departure. An array response dictionary D with R×R elements may be designed. An element of D, indexed by D_{i,j}, which itself may a matrix, where i≤R, j≤R, may given by D_{i,j}=aᵣ(θᵢ) aₜ(θⱼ)^{T}, where

$${θ}_{i} = {θ}_{min} + \frac{i}{R} ( {θ}_{max} - {θ}_{min} ) .$$

Each element of the array response dictionary may be the combination of antenna array responses at the transmitter and receiver for certain values of the angle of arrival and angle of departure. The angles associated with neighboring elements of the dictionary may differ by a value, corresponding to the resolution of the dictionary, specifically,

$$\frac{( {θ}_{max} - {θ}_{min} )}{R} .$$

This dictionary can accordingly be extended to include one or more (e.g., multiple) parameters as well. Accordingly, the size of the dictionary may increase as well. Specifically, if there are N channel parameters, the total number of elements in the channel parameter dictionary may be R^{N}. Additionally or alternatively, the resolution/number of levels/bins, R, associated with each parameter may (e.g., also) be different.

A channel may be constructed from gain-tensor-weighted channel dictionary. Given the parameter dictionary, the channel can be constructed by the addition of specific elements of the same. The role of the deep learning model may be to output a weight tensor W. The size of the weight tensor may be the same as the parameter dictionary (e.g., as described herein). Using the predefined dictionary and/or the output weight matrix, the constructed channel may given by

$$H = {\sum }_{i = 1}^{R} {\sum }_{j}^{R} {W}_{i , j} {D}_{i , j} . \qquad Equation ( 4 )$$

Equation 4 may represent a linearized representation of the channel in terms of the output parameters of the deep neural network.

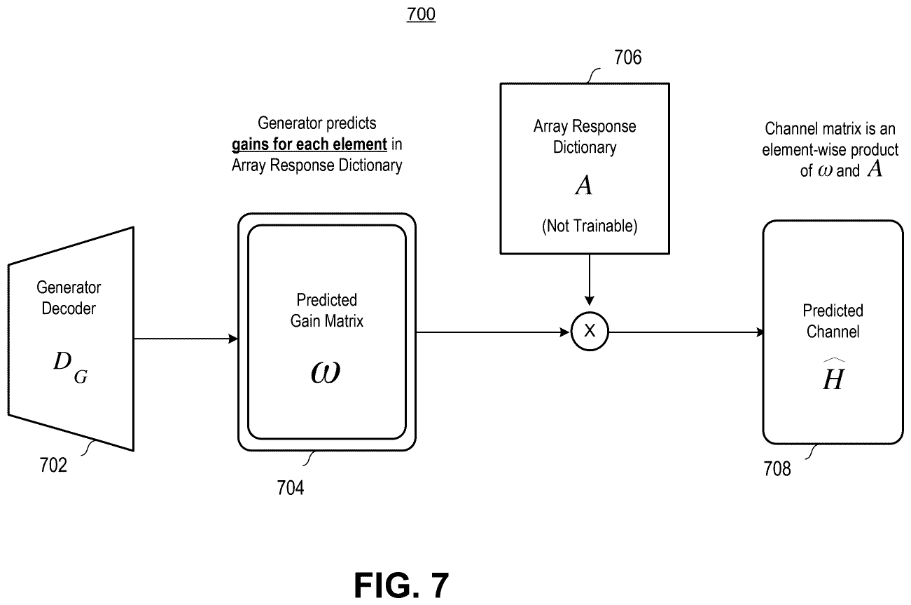

FIG. 7 depicts an example approach for channel construction using the gain tensor and/or parameter dictionary 700. The channel parameter dictionary may be the array response dictionary 706 for the angles of arrival and/or departure in the elevation plane. The block diagram provided in FIG. 7 may provide an overview of the channel construction from a predefined parameter dictionary. In examples, the parameters may be the angles of arrival and departure in the elevation plane. The channel parameter dictionary may (e.g., effectively) be the array response dictionary 706, as described herein. For example, the generator model and/or the generator decoder 702 may predict a gain matrix (e.g., at 704), where the gain matrix may indicate the gains and/or the weights to be multiplied with the elements of the array response dictionary 706. The array response dictionary may include pre-computed entries, and/or may not have (e.g., any) trainable components. Post the elementwise multiplication between the predicted gain matrix and the array response dictionary and followed by summation of one or more (e.g., all) the tensors, the predicted channel matrix may be obtained (e.g., at 708).

In this model, the continuous parameters (e.g., ZoA, ZoD) can be discretized and/or quantized, and/or the effective value(s) of the array response associated with the discrete set of values may be included in an array response dictionary (e.g., 706). For the grid-based model, the ZoD and/or ZoA angles (OB), (Bₐ) may be discretized across their range into one or more

$$( {θ}_{d}^{p} ) , ( {θ}_{a}^{p} )$$

(e.g., a few) bins. For example, consider that these parameters can take a range of values between −90 to +90 degrees. A set of 30 bins and/or 30 discrete values may be considered, that is a bin size of 180/30=6 degrees. The vectors

$${a}_{t} ( {θ}_{d}^{p} )$$

and/or

$${a}_{r} ( {θ}_{a}^{p} )$$

can be evaluated at these 30 values of

$$( {θ}_{d}^{p} ) , ( {θ}_{a}^{p} )$$

respectively. The product of these array responses

$${a}_{t} ( {θ}_{d}^{p} ) {{a}_{r} ( {θ}_{a}^{p} )}^{T}$$

may have 30×30=900 possible values. Equivalently, the array response dictionary may have a total of 900 values and/or the predicted gain matrix (e.g., also) may have 900 entries.

In examples, these parameters can take a range of values between −100 to +100 degrees. A a set of 200 bins and/or 200 discrete values may be considered, that is a bin size of 200/200=1 degrees. The vectors

$${a}_{t} ( {θ}_{d}^{p} ) and {a}_{r} ( {θ}_{a}^{p} )$$

can be evaluated at these 200 values of

$$( {θ}_{d}^{p} ) , ( {θ}_{a}^{p} )$$

respectively. The product of these array responses

$${a}_{t} ( {θ}_{d}^{p} ) {{a}_{r} ( {θ}_{a}^{p} )}^{T}$$

may have 200×200=40,000 possible values. Equivalently, the array response dictionary may have a total of 40,000 values and/or the predicted gain matrix (e.g., also) may have 40,000 entries.

For a sufficiently large value of the dictionary size R, for example, the performance of a grid-based channel construction/generation method may be (e.g., almost) equivalent to the grid-less channel construction/generation method. But differently, since the learnt parameters may be linearly related to the final constructed channel, this approach may not experience the challenges of ill-conditioned loss function for deep neural network (DNN) training. This approach may not scale (e.g., efficiently) with the increase in number of channel parameters. Embodiments described herein may include a (e.g., more generalized) version of the channel construction from a factorized gain tensor. The grid-based channel construction/generation method may include a discrete set of numbers. The grid-less channel construction/generation method may include a continuous set of numbers. As the gap between the grid-based channel construction/generation method and the grid-less channel construction/generation method decreases, for example, the dictionary may become larger and/or the performance gap may become negligible beyond a point (e.g., based on the parameter(s) being discretized).

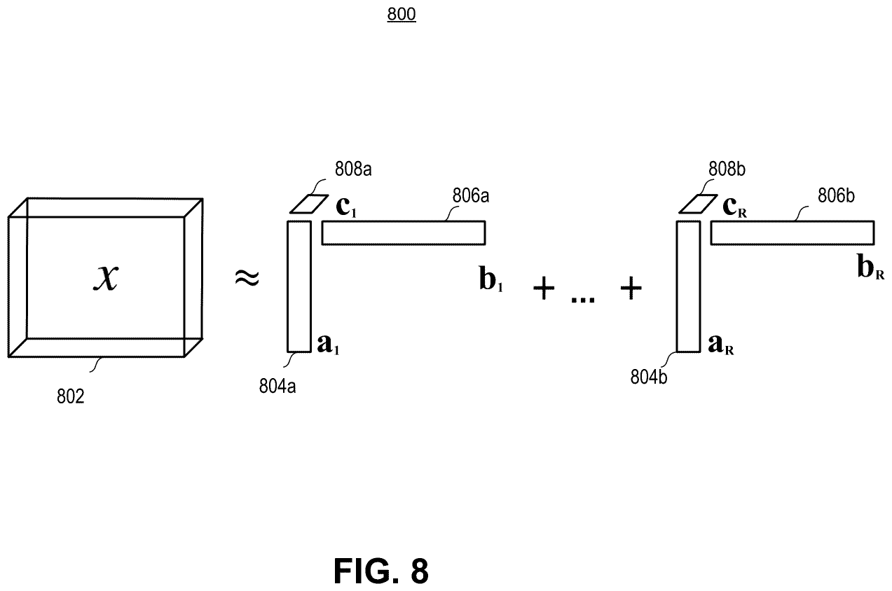

For channel construction using a gain-tensor-weighted dictionary, the number of elements in the dictionary may exponentially scale with the number of channel parameters. For example, there may be two channel parameters considered for each multipath (e.g., angle of arrival and/or angle of departure in the azimuth plane). The number of elements in the dictionary may be R². To utilize this approach with two more channel parameters added per multipath (e.g., the angle of arrival and/or angle of departure in the azimuth plane), the number of elements in the dictionary may increase to R⁴. As a result, the output gain tensor W of the generative model (e.g., see FIG. 8) may (e.g., also) scale accordingly to a size of R⁴. The increased size of the output may make producing gain tensors for a reasonable resolution R computationally prohibitive due to, for example, the exponential increase in size. Embodiments described herein may include an improved approach that scales more efficiently.

Consider the estimation of four channel parameters (e.g., angles of arrival and departure in the elevation plane, and the angles oof arrival and departure in the azimuth plane) per multipath. The respective angles may be denoted by

$$[ {θ}_{E}^{a} , {θ}_{E}^{d} , {θ}_{A}^{a} , {θ}_{A}^{d} ] .$$

To make the computation more tractable, Canonical Polyadic Decomposition (CANDECOMP) may be employed to factorize the gain tensor W. Through CANDECOMP, a tensor Wϵ [symbol] of rank V, may be decomposed into 4 factor matrices F₁, F₂, F₃, F₄ of size R×V each. These matrices can be combined to form W as follows.

$$W [ k , l , m , n ] = {\sum }_{\{ i = 1 \}}^{V} {F}_{1} [ k , i ] \cdot {F}_{2} [ l , i ] \cdot {F}_{3} [ m , i ] \cdot {F}_{4} [ n , i ] . \qquad Equation ( 5 )$$

The above process may amount to successive outer products of the factor matrices F₁,F₂,F₃,F₄.

FIG. 8 illustrates an example of CANDECOMP for a 3-dimensional rank-R tensor 800. The original high dimensional tensor can be broken up into R combinations outer products of 3 tensors, corresponding to each dimension. For example, a high dimensional tensor 802 may be broken up and/or factorized into a₁ 804a to a_{R} 804b, b₁ 806a to b_{R}, 806b, and/or c₁ 808a to c_{R}808b. These factors may be combined to reproduce the original high dimensional tensor 802.

To apply this method to the channel construction from the weight matrix, the maximum number of paths (Pₘₐₓ) that constitute a channel may be defined. As the number of paths of the channel may be equivalent to the rank of the gain tensor W, the size of each factor matrix

$${\{ {F}_{i} \}}_{i = 1}^{{P}_{max}}$$

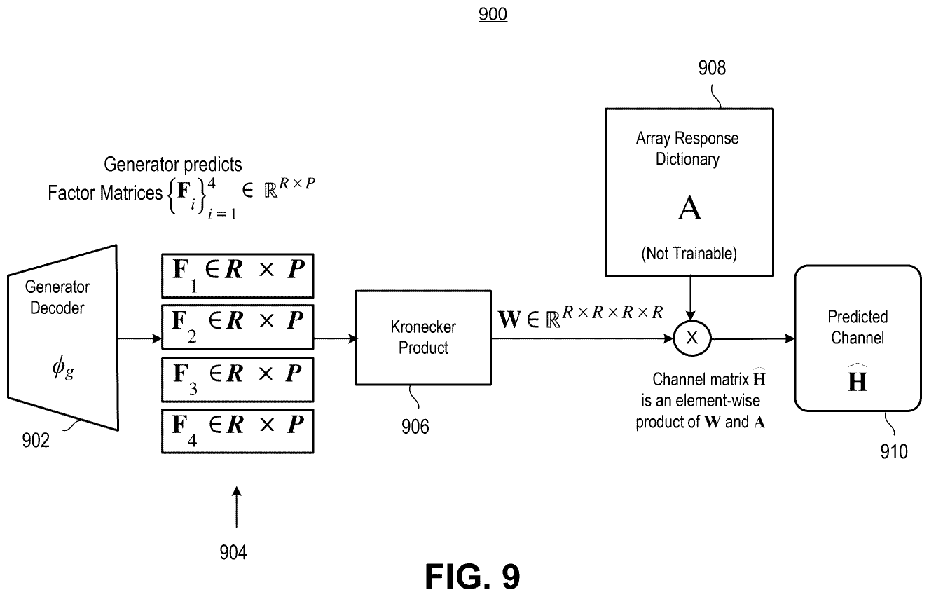

may be at most R×Pₘₐₓ. These factor matrices may (e.g., then) be combined to produce W through successive outer product operations, which may be relatively cheaper in terms of computation. The generator model may be modified to output factor matrices F₁, F₂, F₃, F₄, and/or to combine them through successive outer products to obtain W. Once the gain tensor W is obtained, W may be multiplied by an array dictionary A in an elementwise fashion to produce the predicted channel matrix H. This process is illustrated through FIG. 9.

FIG. 9 depicts an example approach for channel construction using the factorized gain tensor 900. FIG. 9 depicts an example approach that includes a case of channel construction from four parameters (e.g., angles of arrival and departure in the elevation plane, and the angles of arrival and departure in the azimuth plane). The generator and/or generator decoder 902 may predict the factors F1 through F4 (e.g., at 904). These factors may (e.g., then) be combined together using outer products in the kronecker product 906 to produce the weights and/or the gains for the array response dictionary 908. The array response dictionary 908 may include pre-computed entries, and/or may not have (e.g., any) trainable components. Post the element wise multiplication between the predicted gain matrix and the array response dictionary 908, and/or followed by summation of one or more (e.g., all) of the tensors, the predicted channel matrix may be obtained (e.g., at 910).

In this model, the continuous parameters (e.g., ZoA, ZoD) can be discretized and/or quantized, and/or the effective value(s) of the array response associated with the discrete set of values may be included in an array response dictionary. The gain matrix may be factorized to reduce the size of the parameters that may (e.g., need to) be predicted by the generative model. For example, the ZoD and/or ZoA angles

$$( {θ}_{d}^{p} ) , ( {θ}_{a}^{p} )$$

may be discretized across their range into a few bins.

In a first example, these parameters can take a range of values between −90 to +90 degrees. A a set of 30 bins or 30 discrete values may be considered, that is a bin size of 180/30=6 degrees. The vectors

$${a}_{t} ( {θ}_{d}^{p} )$$

and/or

$${a}_{r} ( {θ}_{a}^{p} )$$

can be evaluated at these 30 values of

$$( {θ}_{d}^{p} ) , ( {θ}_{a}^{p} )$$

respectively. The product of these array responses

$${a}_{t} ( {θ}_{d}^{p} ) {{a}_{r} ( {θ}_{a}^{p} )}^{T}$$

may have 30×30=900 possible values. Equivalently, the array response dictionary may have a total of 900 values. Additionally or alternatively, for the grid-based method described herein, the predicted gain matrix may have had 900 entries that were being predicted by the generative model. In the current case where a Factorized gain matrix is considered, the generative model may predict/estimate 2 factor vectors: F1 and F2, where, F1 and F2 have sizes of 30×P. Here P, may refer to the maximum number of dominant paths/clusters that are chosen to consider. In examples, where P=4 is considered, the generative decoder may predict (e.g., only) 2 vectors of size, 30×4=120 entries each. The generative decoder may predict a total of 240 entries (e.g., as compared to the 900 values being predicted/estimated in the previous case).

In a second example (e.g., as described herein), consider that these parameters can take a range of values between −100 to +100 degrees. If a set of 200 bins or 200 discrete values is considered, that is a bin size of 200/200=1 degrees, for example, the vectors

$${a}_{t} ( {θ}_{d}^{p} )$$

and/or

$${a}_{r} ( {θ}_{a}^{p} )$$

) can be evaluated at these 200 values of

$$( {θ}_{d}^{p} ) , ( {θ}_{a}^{p} )$$

respectively. The product of these array responses

$${a}_{t} ( {θ}_{d}^{p} ) {{a}_{r} ( {θ}_{a}^{p} )}^{T}$$

may have 200×200=40,000 possible values. Equivalently, the array response dictionary may have a total of 40,000 values. Additionally or alternatively, for the grid based method described herein, the predicted gain matrix may have had 40,000 entries that were being predicted by the generative model.

In the case where a factorized gain matrix is considered, for example, the generative model may predict/estimate 2 factor vectors: F1 and F2, where, F1 and F2 have sizes of 200×P. Here P may refer to the maximum number if dominant paths/clusters that are chosen to consider. In examples, where P=5 is considered, the generative decoder may predict (e.g., only) 2 vectors of size, 200×5=1000 entries each. The generative decoder may predict a total of 2000 entries (e.g., as compared to the 40,000 values being predicted/estimated in the previous case).

In examples, the WTRU side model may utilize training data from a predesigned training dataset of different channel matrices. This training dataset may be created as per the specifications on the channel parameters, including the angles of arrival and departures in (e.g., both) elevation and/or azimuth, path gains and/or phases for the different multipath components, and/or other relevant parameters mentioned in the configuration (e.g., as described herein).

In examples, the dataset may be split into training, validation, and/or testing samples, with the specific number of samples in each chosen as required. The purpose of each subset may be as follows. The training set may be used to train the network parameters. The validation set may be used to fine tune the hyper parameters (e.g., as described herein, as mentioned in the configuration parameters). Specifically, the performance for the different trained models using the different subset of hyperparameters may be evaluated on the validation set. The set of hyperparameters corresponding to the best performance on the validation dataset may be chosen for the training model. The testing set may be used for the final evaluation of the trained generative model. The considerations for the performance and/or evaluation may be provided herein.

In examples, the final output of the generative model may be the channel matrix. The constriction of the channel model from the generative model may be described herein (e.g., in the forward model).

In examples, the training may be performed on a loss function. The loss function may include one or more (e.g., multiple) components, as described herein. A (e.g., primary) component of the loss function may be the reconstruction term. This may be a loss term that goes to zero when the output of the model is (e.g., exactly) equal to the corresponding samples. One or more (e.g., some) examples of the reconstruction terms may include the mean square error and/or the mean absolute error. The loss function may (e.g., also) include additional regularization terms that may be additively combined with the reconstruction term. A purpose of the regularization term may be to enforce structure in the final output, and/or the output at one or more intermediate layers including sparsity, positivity, and/or magnitude normalization. A regularization term may (e.g., also) enforce structure on the latent space distribution of the generative model, as may be seen for specific case(s) of VAEs. Additionally or alternatively, a regularization term, in the form of weight decay, may (e.g., also) be included. Each of the regularization terms may be weighted by a fixed scalar, that can be chosen by the WTRU as per the requirement(s).

In examples, the training process may be carried out until convergence. This may be decided by the WTRU side and/or can be attained when one or more (e.g., multiple) conditions are met. Met condition(s) may include one or more of the following: attaining a maximum number of apriori specified training epochs; attaining a minimum apriori specified loss function value; no change in loss function beyond an apriori specified margin, and/or one or more other similar metrics.

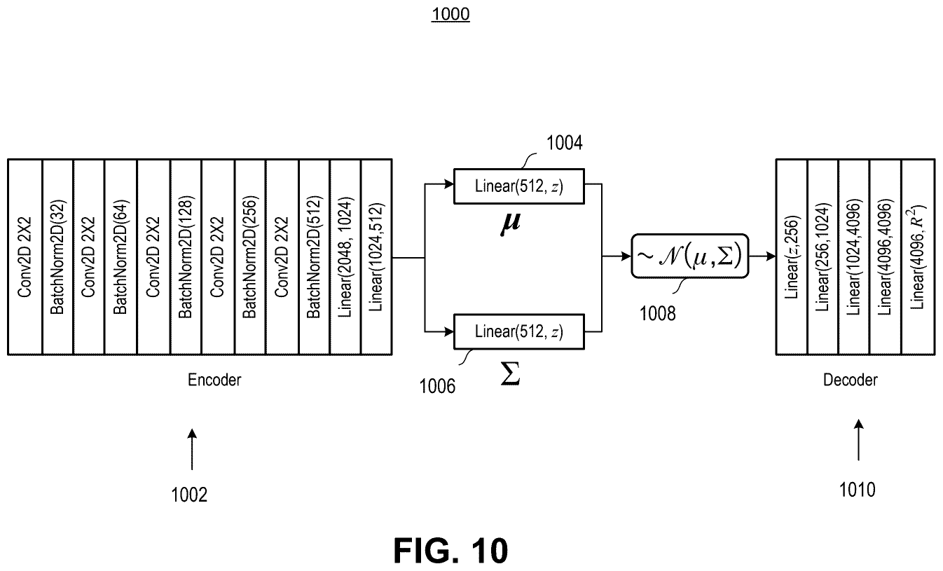

FIG. 10 depicts an example architecture of the VAE based generative model used for training 1000. The VAE based generative model may include an encoder (e.g., 1002) and/or a decoder (e.g., 1010). The model may utilize Leaky ReLU activation after each BatchNorm and/or Linearlayer. The encoder may output parameters relating to the distribution of the latent. The encoder 1002 may output the mean vector (e.g., at 1004), and/or the variance vector (e.g., at 1006). A sampling operation from the latent distribution may be carried out (e.g., at 1008) and/or may be provided as an input to the decoder 1010. Post training, the encoder part of the model may be dropped and/or (e.g., only) the decoder preceded by the sampler may be considered.

In examples, the generation of the channel matrix may be carried out by the generative part of the WTRU side model. An example of such a network may be the decoder network, when the VAE is used. A random variable may be drawn from a latent space distribution, which may include the standard normal distribution and/or the like. This may be passed through the generative network to create a channel matrix sample using the generated weights and/or the multi-parameter dictionary (e.g., as described herein). The performance of the generated samples may be evaluated using metrics such as the 2-Wasserstein distance and/or the like. FIG. 10 depicts the entire VAE based generative model utilized for training. Post training, the encoder part of the model may be dropped and/or (e.g., only) the decoder preceded by the sampler may be considered.

In examples, a different generative model other than a VAE may be utilized for the generative process. For example, a generative adversarial network (GAN) may be utilized, and/or a diffusion based and/or score based model may be utilized.

In examples, the WTRU side model may utilize training data from a predesigned training dataset of different channel matrices. This training dataset may be created as per the specifications on the channel parameters including the angles of arrival and/or departures in (e.g., both) elevation and/or azimuth, path gains and/or phases for the different multipath components, and/or other (e.g., relevant) parameters (e.g., as described herein).

In examples, the dataset may be split into training, validation, and/or testing samples, with a specific number of samples in each chosen as required. A purpose of each subset may be as follows. The training set may be used to train the network parameter(s). The validation set may be used to fine tune the hyper parameters (e.g., as described herein). Specifically, the performance for the different trained models using the different subset of hyperparameters may be evaluated on the validation set. The set of hyperparameters corresponding to the strongest performance on the validation dataset may be chosen for the training model. The testing set may be used for the final evaluation of the trained parameter estimation model.

In examples, the final output of the parameter estimation model may be the actual parameters associated with the channel (e.g., number of multipaths, angles of arrival and/or departure associated with the multipaths, path gain/loss, etc.).

In examples, the final output of the parameter estimation model may be the weight matrix, corresponding to the different channel parameters. This may be used to reconstruct the channel matrix using the different techniques (e.g., as described herein).

In examples, the network may not have prior information about the true value of the channel parameters. The training may be performed on the loss function calculated on the reconstructed input channel matrix using the output parameters of the parameter estimation model and/or the input channel. The loss function (e.g., as described herein) may include one or more (e.g., multiple) components. A (e.g., primary) component of the loss function may be the reconstruction term. This may be a loss term that goes to zero when the output of the model is (e.g., exactly) equal to the corresponding samples. One or more (e.g., some) examples of the reconstruction terms may include the mean square error and/or the mean absolute error. The loss function may (e.g., also) include additional regularization terms that may be additively combined with the reconstruction term. A purpose of the regularization term may be to enforce structure in the final output, and/or the output at one or more intermediate layers including sparsity, positivity, and/or magnitude normalization. Additionally or alternatively, a regularization term, in the form of weight decay, may be included. Each of the regularization terms may be weighted by a fixed scalar, that can be chosen by the WTRU model as per the requirement(s).

In examples, the training process may be carried out until convergence. This may be decided by the WTRU side and/or can be attained when one or more (e.g., multiple) conditions are met. Met condition(s) may include one or more of the following: attaining a maximum number of apriori specified training epochs; attaining a minimum apriori specified loss function value; no change in loss function beyond an apriori specified margin, and/or one or more other similar metrics.

Embodiments described herein may include WTRU and/or network data sharing, signaling, and/or data usage. In examples, the WTRU may use the generative model in inference mode to generate channel information and/or channel sequences and/or may store the generated information into a local dataset. The local dataset may (e.g., later) be used by the WTRU to train (e.g., another) AI/ML model. For example, the WTRU may use the dataset to train an AI/ML model for CSI compression. In examples, the WTRU may combine the generated dataset with a labeled WTRU positioning dataset to improve the training of the WTRU positioning task. In examples, stored channel sequences in the dataset may be used to train an AI/ML temporal CSI prediction model.

In examples, the WTRU may use the generative model to generate training data in real time and/or may use them directly (e.g., without storing the generated data) during the training of another AI/ML model. For example, the WTRU may use the trained generative model to create batches of channel data that may be fed to a CSI compression model during the training. In examples, the WTRU may combine the generated batches of data (e.g., directly) with labeled WTRU positioning data to improve the training of the WTRU positioning task. In examples, generated channel sequences may be used to (e.g., directly) train an AI/ML temporal CSI prediction model.

In examples, the WTRU may use the trained channel generator to create a labeled dataset of channel information and/or best beams. In examples, the WTRU may use the generated channel parameters to find the label for the best beam corresponding to the generated channel. For example, the WTRU may use the angles of arrival (e.g., AoA and/or ZoA) and/or angles of departure (e.g., AoD and/or ZoD) corresponding to the strongest path (e.g., the path with highest path gain) to determine the best beams and/or beam pairs for each generated channel. The WTRU may (e.g., then) combine the channels and the best beams to create a labeled dataset for supervised training of an AI/ML beam prediction model.

In examples, the WTRU may receive an indication (e.g., from gNB) to train and/or send the generative model to the gNB. In examples, the WTRU may sent the trained generative model to the gNB (e.g., to be used by the gNB to generate data and/or train the gNB-sided AI/ML model(s)).

In examples, the WTRU may receive an indication (e.g., from gNB) to train and/or send the generative model to the gNB to be used during the training of a two-sided interoperable model. For example, the trained generative model can be used by the WTRU and/or the gNB (e.g., simultaneously) to train their own autoencoder-based model(s) for CSI compression.

In examples, the WTRU and/or the gNB may use a pre-configured pseudo random number generator(s) to generate the same channel information. The generated channel information may be used to create a shared dataset of channels (e.g., without transmitting a large, shared dataset). For example, the shared dataset can be used with an alignment method (e.g., geometric, topological, etc.) to train interoperable encoder(s) and/or decoder(s).

In examples, the WTRU may use the trained channel parameter estimation model to predict the multi-path parameter(s) of the estimated channels. For example, the predicted-multi-path parameters may include one or more sets of path parameters. For example, each set of path parameters corresponding to a path may include azimuth angle of arrival (AoA), zenith angle of arrival (ZoA), azimuth angle of departure (AoD), zenith angle of departure (ZoD), path gain, phase, delay, and/or doppler shift.

In examples, the WTRU may use the trained channel parameter estimation model to determine the best beams and/or the best beam pairs based on the predicted parameters. For example, the WTRU may use the predicted angles of arrival (e.g., AoA and/or ZoA), angles of departure (e.g., AoD and/or ZoD), corresponding to the strongest paths (e.g., the path with highest path gain) to determine the best beam(s) and/or best beam pairs.

In examples, the WTRU may use the predicted multi-path parameters and/or may format them as a compressed representation of the estimated channel. This compressed representation may be sent to the gNB as CSI-feedback and/or may be used by the gNB to reconstruct the original estimated channel.

In examples, the WTRU may use the trained channel parameter estimation model to create a sequence of channel parameters from an input sequence of estimated channels.

In examples, the WTRU may use (e.g., simple) extrapolation algorithms to predict the one or more (e.g., future) values of each parameter using the sequence of predicted past values for the parameter.

In examples, the WTRU may use the one or more predicted future values of the parameters to reconstruct one or more future channel information.

In examples, the WTRU may use the predicted multi-path parameters to improve the performance of the WTRU positioning model(s). For example, the WTRU may use the predicted multi-path parameter(s) as additional inputs to the WTRU positioning model(s) during the training and/or inference to improve the performance of the model.

In examples, the WTRU may receive an indication (e.g., from gNB) to evaluate the performance of the trained parameter estimation model. The WTRU may use the estimated channels as input to predict the multi-path parameters and/or may use them to reconstruct a predicted channel. The WTRU may (e.g., then) compare the predicted channel information to the original estimated channel. For example, the WTRU may calculate a distance metric (e.g., MSE, NMSE, etc.) and/or may report (e.g., to gNB) the results of evaluation.

In examples, the parameter value(s) obtained as part of the channel estimation process may be utilized for monitoring the performance of a machine learning model deployed for a specific task. For example, for the CSI compression/prediction use case, parameters and/or their distribution may be evaluated; an estimation may be made that the estimated parameters may look (e.g., very) different from the data utilized for training the machine learning model; the model may not perform well. In examples, for the case of deep learning based CSI compression, in addition to sending the deep learning based CSI feedback, the feedback may be supplemented with one or more (e.g., a few) of the parameters as estimated by the channel parameter estimation method. At the base station, the channel may be reconstructed. A (e.g., another) round of channel parameter estimation may be performed; the base station may verify if the same and/or similar parameters were obtained as part of the feedback and/or may estimate the errors and/or performance of the CSI compression framework/model.

Embodiments described herein include physics constrained generative channel model(s) for generating multiple input multiple output (MIMO) data. Methods for generating wireless channel data using ML are described herein. A physics-based constraint in the generative process may ensure that the channels being generated by the ML model are (e.g., all) viable from a physics perspective and/or obey a pre-specified channel model.

A WTRU may receive configuration information associated with one or more of the following. The WTRU may receive configuration information associated with generative model training strategy (e.g., generative adversarial network (GAN), variational auto-encoder (VAE), Diffusion, etc.). The configuration information may include a loss function. The WTRU may receive configuration information associated with the model architecture to use for training. The model architecture to use for training may include one or more of a backbone (e.g., fully connected, Resnet, transformer, etc.), a number of layers, architecture, activation(s), VAE bottle neck, latent space distribution, one or more training parameters, one or more training hyperparameters, and/or stopping criterion. The WTRU may receive configuration information associated with parameter(s) associated with the physics-based model. The parameters may include a model type (e.g., cluster-delay line model (CDL), time delay line model (TDL), Nearfield/farfield, etc.). For example, the model may include

$${\sum }_{k = 1}^{{N}_{p}} {b}_{k} {a}_{R} ( {θ}_{k} ) {a}_{T}^{H} ( {ϕ}_{k} ) \vert ,$$

where θ_k may represent the azimuth angle of arrival (AoA), and/or φ_k may represent the azimuth angle of departure (AoD), and/or b_k may represent gain. The WTRU may receive configuration information associated with model parameters (e.g., number of paths, angle of arrival (AoA), zenith AoA (ZoA), angle of departure (AoD), zenith AoD (ZoD), gain/path loss, phase, doppler, path delay, delay spread, etc.). The WTRU may receive configuration information associated with the optimization reformulation and/or relaxation parameters (e.g., parameter quantization level(s) for each parameter). For example, the WTRU may receive configuration information associated with a range of AoA, a range associated with AoD, a number of discrete AoA angles, a number of discrete AoD angles, and/or a number of discrete phase angles. The WTRU may utilize information about available computational capabilities and/or memory to select one or more (e.g., some) of the parameters (e.g., as described herein).

A WTRU may perform training of the generative model. The WTRU may train the generative AI/ML model based on one or more AI/ML parameters. The one or more AI/ML parameters may include one or more of a generative model training strategy, a model architecture, parameters, hyperparameters, and/or criteria to stop the training of the generative AI/ML model. The WTRU may train the generative AI/ML model based on the loss function and/or training data. The WTRU generative model may introduce the physics-based constraints and/or a physics-based model into the (e.g., overall) generative model architecture and/or training (e.g., channel model). The generative model may include an (e.g., overall) combined architecture. The WTRU may apply a grid-based simplification for the azimuth (e.g., only) setup. For example, the grid-based simplification may include a non-trainability and/or non-convexity of the original problem. For example, the grid-based simplification may include relaxing and/or simplifying the (e.g., overall) problem. For example, the grid-based simplification may include one or more details regarding successful training. Successful training may indicate the model has converged and/or the model has met the required performance criterion (e.g., the loss has reached below a certain threshold). The WTRU may apply a tensor-based simplification for the multi-dimensional multi parameter setup. For example, after simplification is applied, the training of the generative model can be performed. The generative model (e.g., decoder) may predict the tensor component(s) and/or factor(s) (e.g., instead of the complete tensor). The generative AI/ML model may include an autoencoder. The WTRU may be configured to input wireless channel matrices as training data into an encoder of the autoencoder. The encoder may be configured to output parameters relating to the latent vector for training the decoder of the autoencoder.

A WTRU may utilize the trained model for data generation and/or task specific model training. The WTRU may run the model in inference mode for data generation. The WTRU may train task specific model(s) (e.g., channel state information (CSI) compression, CSI prediction), beamforming, etc.) on the generated datasets.

A WTRU may transmit the trained generative model to the base station (BS) for data generation. For example, the WTRU may send a report to a network entity. The report may include an indication of the channel matrix.

Embodiments described herein may include an auto-encoder based unsupervised channel parameter estimation. A method for unsupervised training and/or decomposition of wireless channel tensors into path wise components associated with the multipath channel may be described herein.

A WTRU may receive configuration associated with parameters to be estimated. The WTRU may receive one or more of the following. The WTRU may receive a maximum number of paths that can be estimated and/or an energy threshold associated with the number of paths to be considered. The WTRU may receive angle(s) to be estimated and/or their range. For example, the WTRU may receive azimuth (e.g., only) (e.g., AoA, AoD), elevation (e.g., only) and/or azimuth and elevation. For example, the WTRU may receive a range of each angle AoA, ZoA, AoD, and/or ZoD range. The WTRU may receive a path loss/gain value(s) and/or the associated range. The path loss may be complex and/or real path loss. The WTRU may receive a phase associated with the pathloss/gain and/or associated range. The WTRU may receive a doppler parameter and/or an associated speed and/or phase range. The WTRU may receive a delay spread parameter and/or an associated range. For example, the configuration information may include the channel-related parameters associated with the non-AI/ML (e.g., physics-based) model. The channel-related parameters associated with non-AI/ML (e.g., physics-based) model may include one or more of a number of paths associated with the plurality of paths, an angle of arrival associated with each path of the plurality of paths, an angle of departure associated with each path of the plurality of paths, a path loss coefficient associated with each path of the plurality of paths, a delay spread associated with each path of the plurality of paths, a doppler value associated with each path of the plurality of paths, and/or a delay spread associated with each path of the plurality of paths.

The WTRU may receive configuration about the channel model to be considered (e.g., CDL, TDL, Nearfield, etc.).

The WTRU may receive configuration about the parameter estimation to be used (e.g., autoencoder based unsupervised estimation, optimization based unsupervised estimation, supervised deep learning based estimation).

The WTRU may receive reference symbol(s) and/or pilot(s) and/or may perform channel estimation, and/or may determine the channel parameters including one or more of the following. The WTRU may determine an actual number of paths in the channel Actual number of paths in the channel N_p. The WTRU may determine one or more parameters associated with each of the N_p paths (e.g., angle of arrival (AoA) B_k, angle of departure (AoD) φ_k, Path loss/gain b_k, f_k doppler, δ_k delay, etc.).

The WTRU may utilize the estimated parameters for one or more (e.g., downstream) tasks. For example, the WTRU may utilize the estimated parameters for CSI compression (e.g., reporting the dominant paths and/or associated parameters), CSI prediction (e.g., tracking the dominant paths), beamforming indicating and/or leveraging AoA and/or AoD associated with the dominant paths, positioning (e.g., using the multipath information for positioning), and/or performance monitoring.

1. A wireless transmit/receive unit (WTRU) comprising:
a processor configured to:
sample a latent vector from a pre-defined channel distribution;
input the latent vector to a trained generative artificial intelligence (AI)/machine learning (ML) model, wherein the trained generative AI/ML model is trained to output channel-related parameters associated with each path of a plurality of paths of an over-the-air (OTA) communication channel based on the latent vector;
input the channel-related parameters associated with each path of the plurality of paths of the OTA communication channel to a non-AI/ML model, wherein the non-AI/ML model is configured to produce a channel matrix; and
use the channel matrix to perform one or more of a channel state information (CSI) compression, CSI prediction, beamforming, positioning, or performance monitoring.

2. The WTRU of claim 1, wherein the trained generative AI/ML model comprises a generative adversarial network (GAN) generator model or a trained decoder of an autoencoder.

3. The WTRU of claim 1, wherein the non-AI/ML model comprises a physics-based model, and wherein the trained generative AI/ML model and the physics-based model are portions of a hybrid model configured to operate on the WTRU.

4. The WTRU of claim 3, wherein the physics-based model comprises a predefined channel parameter dictionary and wherein the channel-related parameters are configured to operate as weights for the predefined channel parameter dictionary of the physics-based model.

5. The WTRU of claim 4, wherein the processor is configured to use a factorized gain tensor algorithm associated with the channel parameter dictionary to determine the channel matrix.

6. The WTRU of claim 3, wherein the processor is configured to receive configuration information comprising at least one model type associated with the generative AI/ML model and at least one model type associated with the physics-based model.

7. The WTRU of claim 6, wherein the processor is configured to receive configuration information comprising one or more AI/ML parameters associated with the generative AI/ML model, wherein the processor is configured to train the generative AI/ML model based on the one or more AI/ML parameters, wherein the one or more AI/ML parameters comprise one or more of a generative model training strategy, a model architecture, parameters, hyperparameters, or criteria to stop the training of the generative AI/ML model.

8. The WTRU of claim 7, wherein the configuration information comprises a loss function, wherein the processor is configured to train the generative AI/ML model based on the loss function and training data.

9. The WTRU of claim 8, wherein the generative AI/ML model comprises an autoencoder, wherein the processor is configured to input wireless channel matrices as training data into an encoder of the autoencoder, wherein the encoder is configured to output parameters relating to the latent vector for training the decoder of the autoencoder.

10. The WTRU of claim 6, wherein the configuration information further comprises the channel-related parameters associated with the physics-based model, the channel-related parameters associated with the physics-based model comprise one or more of a number of paths associated with the plurality of paths, an angle of arrival associated with each path of the plurality of paths, an angle of departure associated with each path of the plurality of paths, a path loss coefficient associated with each path of the plurality of paths, a delay spread associated with each path of the plurality of paths, a doppler value associated with each path of the plurality of paths, or a delay spread associated with each path of the plurality of paths.

11. The WTRU of claim 1, wherein the processor is configured to send a report to a network entity, wherein the report comprises an indication of the channel matrix.

12. A method performed by a wireless transmit/receive unit (WTRU), the method comprising:
sampling a latent vector from a pre-defined channel distribution;
inputting the latent vector to a trained generative artificial intelligence (AI)/machine learning (ML) model, wherein the trained generative AI/ML model is trained to output channel-related parameters associated with each path of a plurality of paths of an over-the-air (OTA) communication channel based on the latent vector;
inputting the channel-related parameters associated with each path of the plurality of paths of the OTA communication channel to a non-AI/ML model, wherein the non-AI/ML model is configured to produce a channel matrix; and
using the channel matrix to perform one or more of a channel state information (CSI) compression, CSI prediction, beamforming, positioning, or performance monitoring.

13. The method of claim 12, wherein the trained generative AI/ML model comprises a generative adversarial network (GAN) generator model or a trained decoder of an autoencoder.

14. The method of claim 12, wherein the non-AI/ML model comprises a physics-based model, and wherein the trained generative AI/ML model and the physics-based model are portions of a hybrid model configured to operate on the WTRU.

15. The method of claim 14, wherein the physics-based model comprises a predefined channel parameter dictionary and wherein the channel-related parameters are configured to operate as weights for the predefined channel parameter dictionary of the physics-based model.

16. The method of claim 15, further comprising using a factorized gain tensor algorithm associated with the channel parameter dictionary to determine the channel matrix.

17. The method of claim 14, further comprising receiving configuration information comprising at least one model type associated with the generative AI/ML model and at least one model type associated with the physics-based model.

18. The method of claim 17, further comprising receiving configuration information comprising one or more AI/ML parameters associated with the generative AI/ML model, wherein the method further comprising training the generative AI/ML model based on the one or more AI/ML parameters, wherein the one or more AI/ML parameters comprise one or more of a generative model training strategy, a model architecture, parameters, hyperparameters, or criteria to stop the training of the generative AI/ML model.

19. The method of claim 18, wherein the configuration information comprises a loss function, wherein the processor is configured to train the generative AI/ML model based on the loss function and training data.

20. The method of claim 19, wherein the generative AI/ML model comprises an autoencoder, wherein the method further comprising inputting wireless channel matrices as training data into an encoder of the autoencoder, wherein the encoder is configured to output parameters relating to the latent vector for training the decoder of the autoencoder.

21. The method of claim 17, wherein the configuration information further comprises the channel-related parameters associated with the physics-based model, the channel-related parameters associated with the physics-based model comprise one or more of a number of paths associated with the plurality of paths, an angle of arrival associated with each path of the plurality of paths, an angle of departure associated with each path of the plurality of paths, a path loss coefficient associated with each path of the plurality of paths, a delay spread associated with each path of the plurality of paths, a doppler value associated with each path of the plurality of paths, or a delay spread associated with each path of the plurality of paths.

22. The method of claim 12, further comprising sending a report to a network entity, wherein the report comprises an indication of the channel matrix.
